(19) United States
(12) Patent Application Publication
(10) Pub. No.: US 2026/0135009 A1
(43) Pub. Date: May 14, 2026

(54) RADIOACTIVE SUBSTANCE CONTAINER HAVING A GUIDE STRUCTURE

(71) Applicant: ECZACIBASI MONROL NÜKLEER ÜRÜNLER SANAYI VE TICARET ANONIM SIRKETI, Gebze/Kocaeli (TR)

(72) Inventors: Mehmet Tunç TUNÇEL, Gebze/Kocaeli (TR); Tahsin PEHLIVAN, Gebze/Kocaeli (TR); Isil ÇORUH, Gebze/Kocaeli (TR); Mustafa ÇAKMAK, Gebze/Kocaeli (TR)

(21) Appl. No.: 18/706,268

(22) PCT Filed: Jun. 9, 2022
(86) PCT No.: PCT/TR2022/050549

§ 371 Date: Apr. 30, 2024

(30) Foreign Application Priority Data
Nov. 5, 2021 (TR) 2021/017252

(51) Int. Cl. G21F 5/015; G21F 5/06

(52) U.S. Cl. CPC G21F 5/015; G21F 5/06

(57) ABSTRACT

Disclosed is a radioactive substance container having a guide structure used for storing, carrying and putting into use the radioactive substances. More particularly, the radioactive substance container has an opening, which is intended for providing access to the radioactive substance inside the container, and a guide structure, which enables the structure used for accessing the radioactive substance to be guided in a direction whereby it extends to the center of the container by passing through the center of the opening.

### SUBJECT OF THE INVENTION

The invention relates to a radioactive substance container having a guide structure used for storing, carrying and putting into use the radioactive substances.

### STATE OF THE ART

The radioactive substance containers are used during the carrying and storage of the radioactive substances in order to protect the personnel and the environment from the radiation. Said containers are most of the time armored containers manufactured from lead. Said containers have a body part in which the radioactive substance is positioned and a cover part enabling the body part to be covered. When the radioactive substance within the container is to be used, the cover is opened and the radioactive substance is accessed.

When the radioactive substance has a liquid or powder form, it is commonly stored in a vial or a bottle. In case said substance is in liquid form or is to be used after being dissolved by way of passing a liquid through the vial, the radioactive substance container most of the time has an opening permitting access to the vial. The substance present within the vial is enabled to be drawn by extending a needle through said opening into said vial. When said needle is being extended into the vial, said needle is required to access the vial by passing through the center of said opening. Otherwise, the needle tip may be broken as a result of the needle knocking into the lead.

Owing to the radioactive substance container having a guide structure according to the invention, the needle is enabled to be guided towards the vial owing to the guide structure contained in said radioactive substance container even when said needle is extending in an eccentric direction towards the vial, and in this way, the problems resulting from the needle knocking into the lead are prevented.

### OBJECT OF THE INVENTION

An object of the invention relates to a radioactive substance container enabling the needle, which is used for transferring the substance present inside said radioactive substance container from said container, to access the interior of said container by passing through the center of the opening available on said container.

Another object of the invention relates to a radioactive substance container having an opening with conical structure, which guides the needle towards the center of the container without the tip of said needle being broken, even when said needle is extending to the interior of said container in a direction other than the direction towards the center of said container.

### DESCRIPTION OF THE FIGURES

FIG. 1: An isometric view of the radioactive substance container according to the state of the art

FIG. 2: A sectional view of the radioactive substance container according to the state of the art in a state positioned over the needle

FIG. 3: A view of the radioactive substance container according to the invention

FIG. 4: A sectional view of the radioactive substance container according to the invention while being positioned over the needle

FIG. 5: A sectional view of the radioactive substance container according to the invention in a state positioned over the needle

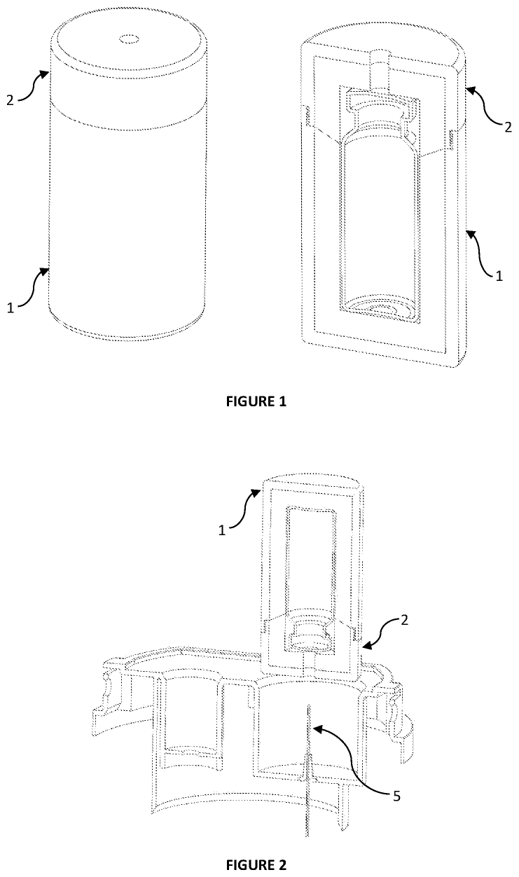

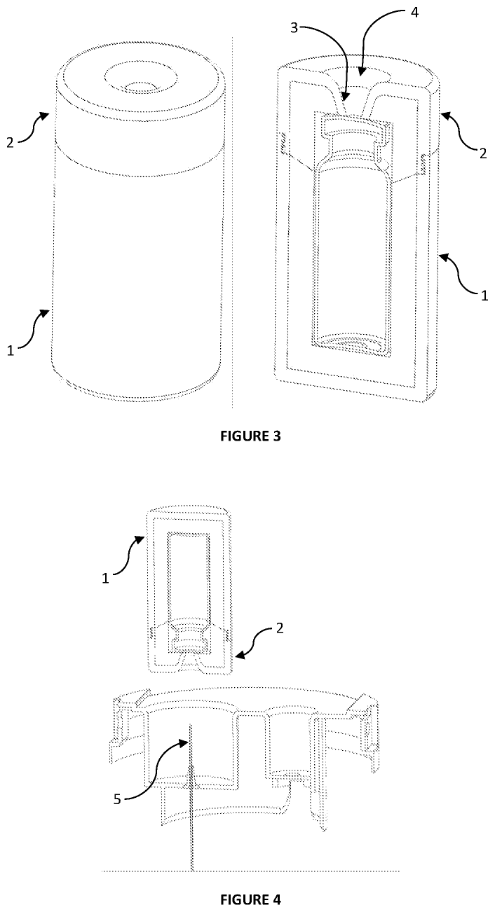

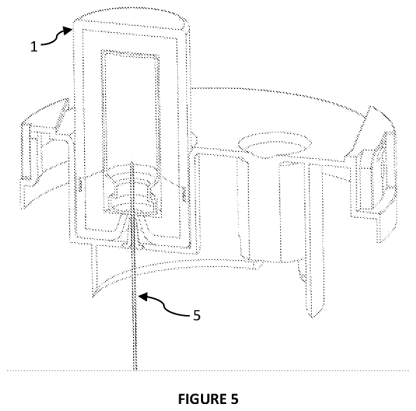

### REFERENCE NUMERALS

1: Body
2: Cover
3: Guide structure
4: Opening
5: Transfer member

### DETAILED DESCRIPTION OF THE INVENTION

The invention relates to a radioactive substance container having a guide structure (3) used for storing, carrying and putting into use the radioactive substances. More particularly, the invention relates to a radioactive substance container having an opening (4), which is intended for providing access to the radioactive substance inside the container, and a guide structure (3), which enables the structure used for accessing the radioactive substance to be guided in a direction whereby it extends to the center of the container by passing through the center of the opening (4).

The radioactive substance container according to the invention comprises, in its most basic form, at least one body (1) having at least one space in which the radioactive substance is to be positioned, and at least one cover (2) enabling the top of the body (1) to be covered and having at least one opening (4) for permitting access to the interior of the body (1). In order to perform the transfer of the radioactive substance, which is present inside the container according to the invention, to the area of use, at least one transfer member (5) is extended through said opening (4) into the body (1). The body (1) has at least one storage vessel housing, into which the storage vessel is positioned, and the transfer member (5) entering the body (1) via the opening (4) extends to at least one storage vessel, which is located inside the body (1) and in which the radioactive substance is stored. The transfer member (5) accesses the radioactive substance by piercing through the structure on the storage vessel and the radioactive substance is carried by the transfer member (5) to the area of use. The storage vessel is preferably a vial or a bottle and the transfer member (5) is preferably a needle.

The opening (4) has at least one guide structure (3), which enables the transfer member (5) to be guided towards the center of the body (1) and thus towards the center of the storage vessel while said transfer member (5) is passing through said opening (4). Said guide structure (3) is preferably integrated with the opening (4) on the cover (2). Owing to said guide structure (3), the diameter of the end of the opening (4) farthest from the body (1) is greater than the diameter of the end of the opening (4) nearest to the body (1). More specifically, the diameter of the opening (4) decreases while approaching the body (1) and increases while moving away from the body (1). In other words, the opening (4) assumes a conical form owing to the guide structure (3). In this way, the transfer member (5) is enabled to enter the opening (4) through a relatively wide diameter, but it is then enabled to be guided towards the center of the body (1) owing to the narrowing structure. Thus, the problem that the transfer member (5) becomes broken or bent by knocking into the lead as a result of said transfer member (5) failing to advance towards the center of the body (1), in other words, as a result of said transfer member (5) entering the opening (4) by a section other than the desired point, is eliminated.

In a preferred embodiment of the invention, the radioactive substance container is a container manufactured from lead.

1. A radioactive substance container used for storing, carrying radioactive substances and putting radioactive substances into use wherein the radioactive substance container comprises:
at least one body having at least one space in which the radioactive substance is to be positioned, and
at least one cover enabling a top of the body to be covered and having at least one opening for permitting access to an interior of the body.

2. A radioactive substance container according to claim 1, wherein said opening is an opening, which permits at least one transfer member to extend into the body for the transfer of the radioactive substance present inside the container to an area of use.

3. A radioactive substance container according to claim 1, wherein the body has at least one storage vessel housing, which allows the radioactive substance to be placed into the body via at least one storage vessel.

4. A radioactive substance container according to claim 3, wherein the storage vessel is a storage vessel with a structure permitting a transfer member to access the radioactive substance by piercing through the structure on said storage vessel.

5. A radioactive substance container according to claim 3, wherein the body has at least one storage vessel housing, which allows the radioactive substance to be placed into the body via at least one vial or bottle.

6. A radioactive substance container according to claim 1, wherein the radioactive substance container has at least one guide structure, which enables a transfer member to be guided towards the center of the body and thus towards the center of the storage vessel while said transfer member is passing through the opening.

7. A radioactive substance container according to claim 6, wherein the guide structure has a structure integrated with the opening.

8. A radioactive substance container according to claim 6, wherein the guide structure is a guide structure which ensures that the diameter of the end of the opening farthest from the body is greater than the diameter of the end of the opening nearest to the body.

9. A radioactive substance container according to claim 6, wherein the opening is an opening, the diameter of which decreases while approaching the body and increases while moving away from the body.

10. A radioactive substance container according to claim 1, wherein the opening has a conical structure.

11. A radioactive substance container according to claim 6, wherein the guide structure has a conical structure.

12. A radioactive substance container according to claim 1, wherein said container is manufactured from lead.
